(19) United States
(12) Patent Application Publication
(10) Pub. No.: US 2022/0188843 A1
(43) Pub. Date: Jun. 16, 2022

(54) Surrogate Ground Truth Generation in Artificial Intelligence based Marketing Campaigns

(71) Applicant: FMR LLC, Boston, MA (US)

(72) Inventors: Filip Michalsky, Boston, MA (US); Serdar Kadioglu, Boston, MA (US)

(21) Appl. No.: 17/122,362

(22) Filed: Dec. 15, 2020

(51) Int. Cl. G06Q 30/02; G06Q 10/06; G06N 20/00

(52) U.S. Cl. CPC G06Q 30/0201; G06N 20/00; G06Q 10/06393; G06Q 30/0203

(57) ABSTRACT

A computer-implemented method is provided for determining surrogate ground truth to enable fairness evaluation after completion of a campaign of interest. The surrogate ground truth indicates individuals who should have been contacted by the campaign of interest. The method includes receiving data for the campaign of interest and data for a previous campaign in relation to a population group selected for the previous campaign. The method also includes generating, before commencement of the campaign of interest, control and treatment models trained based on data collected from the previous campaign. The method further includes calculating, after completion of the campaign of interest, the surrogate ground truth using the trained control and treatment models and data collected from the campaign of interest.

### TECHNICAL FIELD

This application relates generally to systems, methods and apparatuses, including computer program products, for determining surrogate ground truth to enable fairness evaluation after completion of a campaign of interest.

### BACKGROUND

Many companies today have an interest in evaluating fairness of their artificial intelligence (AI) models used to select participants in marketing campaigns, especially in view of inherent bias and discrimination introduced into these models from, for example, the underlying datasets used to train these models.

In general, AI-based marketing campaign models fall under two broad types. The first type is a propensity model configured to predict the probability that a customer in a certain target population is likely to take a certain action, such as purchase a certain product. Based on the predicted likelihood, a company may take certain intervention measures, such as contact the customer to encourage such purchase. One serious drawback associated with this type of propensity model is that it does not have the ability to detect customers who would have taken an action without the intervention. To rectify this shortcoming, a second type of marketing campaign model, a “lift model,” can be used. Lift models divide the target population into treatment and control groups and model the effect of an intervention as a “lift” in a certain key performance indicator (KPI) given the intervention. The customers who are most likely to increase the KPI after an intervention (e.g., the lift in buying a certain product based on whether the customer receives a call versus not receiving a call) can be ranked. A lift model thus allows a marketing campaign to target customers who are truly likely to benefit from the intervention.

In general, bias and discrimination can exist in both propensity and lift models. Even though several fairness evaluation metrics can be applied to enhance fairness, they heavily depend on the availability of ground truth labels that identify individuals who should be contacted by a marketing campaign. For propensity models, a population can be scored to perform a certain action without intervention, and a ground truth response can be observed. For lift models, however, ground truth identification is difficult given the inherently different actions taken in treatment and control groups. For example, in a lift model it is difficult to quantify who “should have been called” after an experiment is completed. Thus, in the absence of such ground truth, fairness evaluation is very limited for lift models.

Therefore, systems and methods are needed to prevent lift-model based marketing campaigns from treating protected groups (e.g., based on gender and/or race) unfairly. Such systems and methods are desirable because they can minimize a company's exposure to reputational and economical damages as a result of applying biased algorithms that are likely to generate biased predictions.

### SUMMARY

The systems and methods of the present invention generate surrogate ground truth labels for the purpose of fairness evaluation in artificial intelligence/machine learning based marketing campaigns associated with lift models. These systems and methods can minimize (e.g., suppress) unwanted biases with respect to protected groups in AI/machine-learning algorithms, where the biases are introduced, for example, from underlying datasets. In some embodiments, the present invention features machine learning algorithms capable of determining which customers should receive intervention in a marketing campaign and generating surrogate ground truth data from the identified customers, based on which the marketing campaign can be evaluated from an AI fairness perspective.

In one aspect, a computer-implemented method is provided for determining surrogate ground truth to enable fairness evaluation after completion of a campaign of interest. The surrogate ground truth indicates individuals who should have been contacted by the campaign of interest. The computer-implemented method includes receiving, by a computing device, (i) data for the campaign of interest and (ii) data for a previous campaign in relation to a population group selected for the previous campaign. The method includes performing, by the computing device before commencement of the campaign of interest, steps including generating a trained lift model to predict one or more effects of the previous campaign with respect to at least one key performance indicator (KPI) among the population group, where the trained lift model includes a trained control model and a trained treatment model, ranking the population group based on the trained lift model to generate an initial ranking, and selecting individuals from the population group to contact by the campaign of interest based on the initial ranking. The method further includes calculating, by the computing device after completion of the campaign of interest, the surrogate ground truth. This surrogate truth calculation includes determining actual KPI scores for individuals in a first subgroup of the population group that were reached by the campaign of interest, scoring the first subgroup with the trained control model to generate estimated KPI scores for the individuals in the first subgroup, where each estimated KPI score represents an estimated KPI that the corresponding individual would generate had the individual not been reached by the campaign of interest, and determining lift scores for the individuals in the first subgroup by subtracting the estimated KPI scores from the actual KPI scores of the first subgroup. The surrogate ground truth calculation also includes determining actual KPI scores for individuals in a second subgroup of the population group that were not reached by the campaign of interest, scoring the second subgroup with the trained treatment model to generate estimated KPI scores for the individuals in the second subgroup, where each score represents an estimated KPI that the corresponding individual would generate had the individual been reached by the campaign of interest, and determining lift scores for the individuals in the second subgroup by subtracting the actual KPI scores from the estimated KPI scores of the second subgroup. The surrogate ground truth for the campaign of interest is calculated based on the lift scores for the first and second subgroups.

In another aspect, a computer-implemented system is provided for determining surrogate ground truth to enable fairness evaluation after completion of a campaign of interest. The surrogate ground truth reveals individuals who should have been contacted by the campaign of interest. The computer-implemented system comprises an input module for receiving data for the campaign of interest and data for a previous campaign in relation to a population group selected for the previous campaign. The system also comprises a lift model generator configured to generate, before commencement of the campaign of interest: (i) a trained lift model, including a trained control model and a trained treatment model, to predict one or more effects of the previous campaign with respect to at least one key performance indicator (KPI) among the population group, (ii) an initial ranking of the population group based on the trained lift model, and (iii) individuals selected from the population group to contact by the campaign of interest based on the initial ranking. The system also includes a scoring engine configured to generate, after completion of the campaign of interest, (i) lift scores for individuals in a first subgroup of the population group that were reached by the campaign of interest based on the trained control model and (ii) lift scores for individuals in a second subgroup of the population group that were not reached by the campaign of interest based on the trained treatment model. The computer-implemented system further includes a ground truth calculation module configured to calculate the surrogate ground truth for the campaign of interest based on the lift scores for the first and second subgroups, and a fairness evaluation library for storing one or more binary fairness metrics applicable to the surrogate ground truth to uncover unintended bias.

Any of the above aspects can include one or more of the following features. In some embodiments, the trained T model is trained using data of individuals in the population group who were reached by the previous campaign, and the trained C model is trained using data of individuals in the population group who were not reached by the previous campaign.

In some embodiments, prior to the commencement of the campaign of interest, the population group is scored using the trained T model to generate a first set of KPI scores that predict the KPI for the individual the population group who were reached by the previous campaign. The population group is also scored using the trained C model to generate a second set of KPI scores that predict the KPI for the individuals in the population group who were not reached by the previous campaign. The first and second sets of KPI scores are combined to generate a set of initial lift scores for the population group. In some embodiments, the initial ranking is generated by ranking individuals in the population group based on their respective initial lift scores. In some embodiments, selecting the individuals to contact by the campaign of interest comprises selecting individuals from the initial ranking of the population group who have initial lift scores higher than a predefined threshold score.

In some embodiments, calculating the surrogate ground truth for the campaign of interest based on the lift scores for the first and second subgroups includes combining the lift scores for the first and second subgroups to form a combined set of lift scores, ranking individuals in the population group based on their corresponding lift scores in the combined set of lift scores, and selecting individuals from the population group based on the ranking. The selected individuals represent the surrogate ground truth of those who should have been contacted by the campaign of interest. In some embodiments, selecting individuals from the population group to represent the surrogate ground truth comprises selecting individuals from the ranking of the population group after the completion of the campaign of interest who have lift scores higher than a predefined threshold score.

In some embodiments, similarity is determined between the ranking of the population group after the completion of the campaign of interest and the initial ranking of the population group to determine effectiveness of the campaign of interest. In some embodiment, one or more binary fairness metrics are computed based on the initial ranking and the surrogate ground truth to uncover unintended bias with respect to one or more protected attributes. The one or more binary fairness metrics can include at least one of statistical parity, disparate impact, predictive equality, equal opportunity, false negative rate (FNR) difference, average odds, and generalized entropy index and Theil index.

In some embodiments, a higher value in the lift score for an individual in the first subgroup corresponds to a better decision of the campaign of interest to contact the individual. In some embodiments, a lower value in the lift score for an individual in the second subgroup corresponds to a better decision of the campaign of interest to not contact the individual.

In some embodiments, scoring the first subgroup with the trained control model comprises using attributes of the individuals in the first subgroup at the end of the campaign of interest in the control model. In some embodiments, scoring the second subgroup with the trained treatment model comprises using attributes of the individuals in the second subgroup at the end of the campaign of interest in the treatment model. In some embodiments, at least one of the control model or the treatment model comprises a regression model.

In some embodiments, the KPI represents an amount of net monetary flow in purchase or asset transfer in a given time duration. In some embodiments, the lift model, including the control model and the treatment model, is trained prior to the commencement of the campaign of interest using artificial intelligence, including machine learning.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary diagram of a system used in a computing environment in which ground truth and fairness of an artificial-intelligence based marketing campaign are determined, according to some embodiments of the present invention.

FIG. 2 shows an exemplary process implemented by the system of FIG. 1 to perform ground truth determination and fairness evaluation, according to some embodiments of the present invention.

FIG. 3 shows an exemplary implementation of the scoring phase of the process of FIG. 2, according to some embodiments of the present invention.

FIG. 4 shows an exemplary process implementing the ground truth generation phase of the process of FIG. 2, according to some embodiments of the present invention.

### DETAILED DESCRIPTION

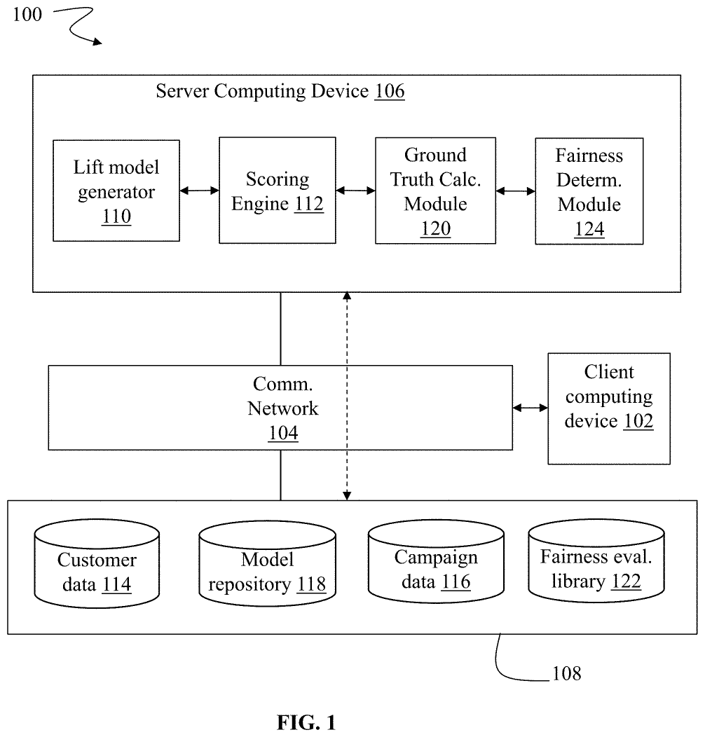

FIG. 1 shows an exemplary diagram of a system 100 used in a computing environment in which ground truth and fairness of an artificial-intelligence based marketing campaign are determined, according to some embodiments of the present invention. As shown, the system 100 generally includes a client computing device 102, a communications network 104, a data store 108, and a server computing device 106.

The client computing device 102 connects to the communications network 104 to communicate with the server computing device 106 and/or the data store 108 to provide input and receive output relating to the process of ground truth determination and fairness evaluation. For example, the client computing device 102 can provide a detailed graphical user interface (GUI) that presents output resulting from the analysis methods and systems described herein, where the GUI can be utilized by a user to review and/or modify inputs and/or outputs generated by the system 100. In some embodiments, a user is a business stakeholder who has an interest in learning the fairness evaluation results of a marketing campaign. In some embodiments, a user is a sales representative who can contact customers select customers based on the evaluation results. Exemplary client computing devices 102 include but are not limited to desktop computers, laptop computers, tablets, mobile devices, smartphones, and internet appliances. It should be appreciated that other types of computing devices that are capable of connecting to the components of the system 100 can be used without departing from the scope of invention. Although FIG. 1 depicts a single client device 102, it should be appreciated that the system 100 can include any number of client devices.

The communication network 104 enables components of the system 100 to communicate with each other to perform the process of ground truth determination and fairness evaluation as described herein. The network 104 may be a local network, such as a LAN, or a wide area network, such as the Internet and/or a cellular network. In some embodiments, the network 104 is comprised of several discrete networks and/or sub-networks (e.g., cellular to Internet) that enable the components of the system 100 to communicate with each other.

The server computing device 106 is a combination of hardware, including one or more processors and one or more physical memory modules and specialized software engines that execute on the processor of the server computing device 106, to receive data from other components of the system 100, transmit data to other components of the system 100, and perform functions as described herein. As shown, the processor of the server computing device 106 executes a lift model generator 110, a scoring engine 112, a ground truth calculation module 120, and a fairness determination module 124, where the sub-components and functionalities of these components are described below in detail. In some embodiments, the components 110, 112, 120 and 124 are specialized sets of computer software instructions programmed onto a dedicated processor in the server computing device 106 and can include specifically-designated memory locations and/or registers for executing the specialized computer software instructions.

The data store 108 is a computing device (or in some embodiments, a set of computing devices) that is coupled to and in data communication with the server computing device 106 and is configured to provide, receive and store customer data 114, campaign data 116, model repository 116 and fairness evaluation library 122. The customer data 114 provides information about customers of current, ongoing, and past marketing campaigns, where each customer is an individual who either received intervention from (e.g., contacted by) a campaign or is identified by a campaign to receive potential intervention. The campaign data 116 provides information about one or more of a current, ongoing or past campaign, such as the campaign start date, campaign end date and identification of customers to receive intervention during the campaign. The model repository 118 stores one or more lift models generated by the evaluation process of the present invention. The fairness evaluation library 122 stores one or more fairness metrics (e.g., binary fairness metrics) applicable to the surrogate ground truth determined for a marketing campaign for the purpose of uncovering unintended biases in the campaigns. Details regarding these different types of data is escribed below. In some embodiments, all or a portion of the data store 108 is integrated with the server computing device 106 or located on a separate computing device or devices. For example, the data store 108 can comprise one or more databases, such as MySQL™ available from Oracle Corp. of Redwood City, Calif.

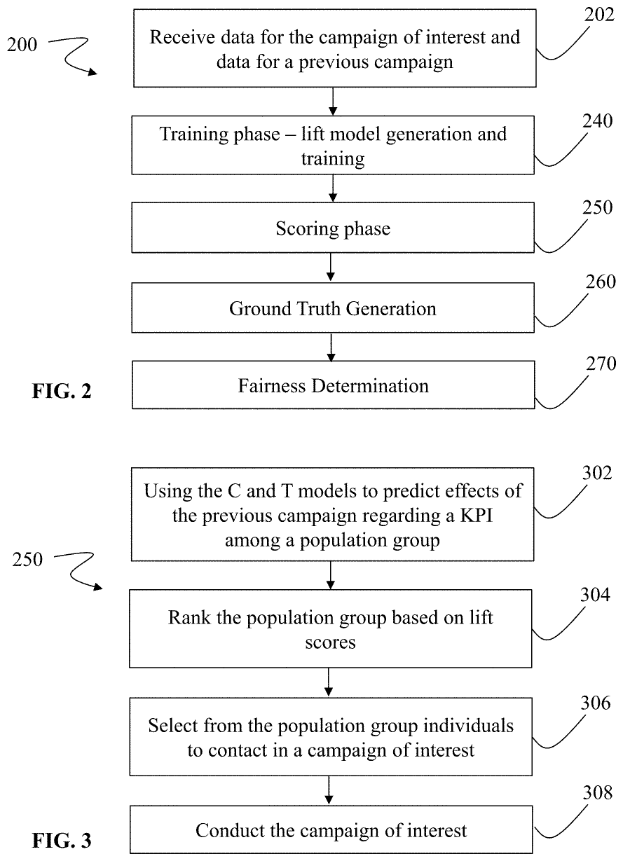

FIG. 2 shows an exemplary process 200 implemented by the system 100 of FIG. 1 to perform ground truth determination and fairness evaluation, according to some embodiments of the present invention. Specifically, the process 200 determines surrogate ground truth associated with a campaign of interest after the completion of the campaign, where the surrogate ground truth indicates those individuals who should have been contacted by the campaign of interest. Thereafter, fairness of the campaign of interest can be evaluated based on the surrogate ground truth determined.

The process 200 starts (at step 202) by receiving data for the campaign of interest and data for at least one previous campaign. In some embodiments, the previous campaign is related to the campaign of interest in one or more commercial aspects, such as the same or similar products marketed and/or the same or similar marketing demographics (e.g., a customer segmentation that purchased another company products). Another similarity between the campaign of interest and previous campaign can include similarity in KPI objectives, such as predicting the likelihood of a customer opening one type of an investment account after calling the customer in the previous campaign and predicting the same with another similar type of investment account in the current campaign of interest. Another KPI similarity can be that both the previous and current campaigns are appointment related. For example, the KPI for the previous campaign can comprise scheduling an appointment upon customer representative call, while the KPI of the current campaign of interest can be based on a text message call to action. The data for the campaign of interest and the previous campaign can be stored in the campaign database 116 and the customer database 114 of the data store 108 of FIG. 1. For example, information about a population of customers targeted by each campaign can be stored in the customer database 114, while other information about each campaign, such as the campaign start and end dates and products marketed during the campaign, can be stored in the campaign database 116.

Prior to the commencement of the campaign of interest, the lift model generator 110 of the system 100 of FIG. 1 generates a trained lift model in a training phase of the process 200 (step 240). The trained lift model is usable by the campaign of interest to select a group of customers for receiving intervention. The lift model can be trained using the data collected from the previous marketing campaign to predict how the previous campaign affected the population group with respect to at least one key performance indicator (KPI). For example, the KPI can represent a net monetary flow, and the lift model can be trained to predict an amount of net monetary flow in purchase of a marketed product in a given time duration (e.g., 90 days) after the previous campaign ended.

For the purpose of training the lift model, the population group targeted by the previous campaign is divided into a first group of individuals who were considered and reached by the previous campaign and a second group of individuals who were considered, but not contacted or reached by the previous campaign. In some embodiment, the population group was selected on the basis of one or more business rules or other non-AI selection criteria.

Generating/training the lift model by the lift model generator 110 (at step 240) includes training a treatment (T) model and a control (C) model of the lift model using an artificial intelligence algorithm, e.g., a supervised machine learning approach, based on characteristics of the first group and/or second group of individuals. Specifically, the T model is trained based on data of the first group of individuals who were considered and reached by the previous campaign. The data can be certain attributes of these customers, such as demographics, financials and past interactions with the company's representatives. In general, the T model can be used to predict a given KPI (e.g., the net monetary flow generated within a certain number of days after the previous campaign ended) for the individuals who received intervention (e.g., a marketing call) during the previous campaign. In some embodiments, the T model is a linear model, such as Linear Regression, configured to predict continuous dependent variable of a customer related to, for example, monetary inflows. To train the T model using linear regression, first provide a dataset (X, Y) where X is a set of independent variables and Y is a dependent continuous variable for which prediction is needed. Such model can be expressed by the following equation: y(x)=β₀+β₁x₁+β₂x₂+ . . . +βₙxₙ=βX, where βᵢ, i∈n are weight coefficients for each independent variable xᵢ∈X and a bias term β₀. To calculate these coefficients, there exists a closed-form solution via least-squares estimation technique: β=(X^{T}X)⁻¹X^{T}Y. In another example, the linear T model is trained using Logistic Regression to predict propensity (i.e., probability) of a customer to take a certain action. To train the T model using logistic regression, consider a dataset (X, Y) where X is a set of independent variables and Y is a dependent variable with binary values (0 or 1) for which prediction is needed. Such model then models the propensity (or likelihood) of an individual customer to take a certain action. It can be expressed by the following equation:

$$y ( ϕ ) = σ ( {w}^{T} ϕ ) = \frac{1}{1 + exp ( - {w}^{T} ( ϕ )} ,$$

where ϕ is a set of features i.e., customer attributes xᵢ where xᵢ∈X, y is the probability that the dependent variable Y is equal to 1, and w is a vector of weights associated with each feature x from the vector of features ϕ. Training the model involves optimizing the weights w to minimize the error of predictions from such a model on a target variable Y. A cost function is used to represent the error such as cross-entropy: E(w)=−Σₙ₌₁^{N}yⁿ log ŷₙ+(1−yₙ) log(1−ŷₙ), where yₙ represents the target label and ŷₙ=σ(aₙ)=σ(w^{T}ϕn) represents the prediction of the model. To update weights w at a time step t+1, the gradient of the cost function is first calculated: ∇E(w)=Σₙ₌₁^{N}(ŷₙ−yₙ)ϕₙ. Then weights are updated via stochastic gradient descent as follows: w(t+1)=w(t)−η∇E(w), where η is the learning rate. The last two equations are repeatedly calculated for a number of time steps until convergence of the error term below some pre-defined threshold E or in a pre-defined number of iterations. In other embodiments, the present invention can use one or more non-linear models to compute the T model, as described in detail below.

In some embodiments, the C model is trained in a similar fashion as the T model, except based on the attribute data of the second group of individuals who were considered but not contacted or reached by the previous campaign. The C model can be used to predict the KPI (e.g., the net monetary flow generated within a certain number of days after the previous campaign ended) for the individuals who did not receive intervention during the previous campaign.

In some embodiments, at least one of T model or the C model is a regression model. In some embodiments, the T or C model is a non-linear model generated based on, for example, Extreme Gradient Boosting Trees Algorithm or Feedforward Neural Network algorithm. In some embodiments, the T or C model is a linear model generated based on, for example, Linear Logistic Regression algorithm or Logistic Regression algorithm (where KPI represents a probability score between 0 and 1). In some embodiments, the trained T and C models of the lift model (and any related data) are stored in the model repository 118 of the data store 108 of FIG. 1.

After the training phase at step 240, the scoring engine 112 of the system 100 is configured to execute a scoring phase (step 250). The scoring phase identifies individuals from the population group of the previous campaign to receive intervention in the current campaign of interest based on the trained T and C models created from the training phase 240. Further, during the scoring phase 250, the current campaign of interest is conducted by targeting (e.g., calling) the selected individuals to receive advertisement of products marketed by the current campaign.

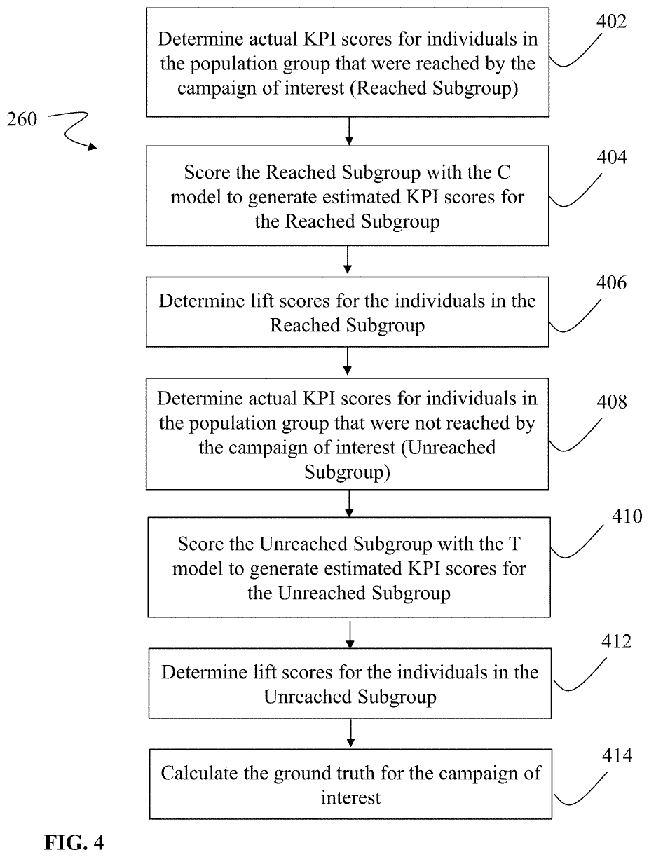

FIG. 3 shows an exemplary implementation of the scoring phase 250 of the process 200 of FIG. 2, according to some embodiments of the present invention. As shown, at step 302, the scoring engine 112 computes (i) a first set of KPI scores for the individuals of the population group using the trained T model and (ii) a second set of KPI scores for the individuals of the population group using the trained C model. Specifically, the first set of KPI scores is generated by applying the trained T model to predict the KPI for the individuals who received intervention from the previous campaign. For example, if the KPI represents a net monetary flow, the KPI scores from the T model predict the net monetary flow generated by the customers purchasing the marketed product in a given time period (e.g., next 90 days) after receiving intervention in the previous campaign. The second set of KPI scores is generated by applying the trained C model to predict the KPI for the individuals who did not receive intervention by the previous campaign. For example, the KIP scores from the C model can predict the net monetary flow generated by the customers purchasing the marketed product in a given time period (e.g., next 90 days) in the absence of any intervention from the previous campaign. Further, at step 302, a set of lift scores for the previous campaign can be generated by subtracting the KPI scores of the C model from the KPI scores of the T model. Each lift score represents the predicted positive impact on the corresponding individual from having received intervention (e.g., a call from customer representative) in the previous campaign.

In addition, individuals of the population group can be ranked based on their corresponding lift scores (step 304). Further, during the scoring phase 250, certain individuals from the population group can be selected to receive intervention in the current campaign of interest once it starts (step 306). This selection can include selecting individuals from the ranking of the population group (from step 304) for the previous campaign who have lift scores exceeding a predefined threshold score, such as within top 10% of the ranked population group. Thus, the AI models of the present invention, which includes the T and C models, can be used to decide who to call in a marketing campaign of interest. In some embodiments, information related to the selected individuals for the campaign of interest are stored in the campaign database 116 and/or the customer database 114.

At step 308, the campaign of interest can be conducted from a start time to an end time by trying to provide intervention to the individuals identified using the artificial-intelligence models trained from data of the previous marketing campaign. For example, company representatives can make calls to these individuals. Data related to the intervention can be collected and stored in the campaign database 116 of the data store 108 of FIG. 1. The data can include a list of individuals who were contacted and reached by the campaign of interest (along with pertinent customer information), a list of individuals who were not contacted/reached by the campaign of interest (along with pertinent customer information), topics discussed, and any other marketing campaign related data.

Referring back to FIG. 2, after the conclusion of the campaign of interest in the scoring phase 250, the ground truth calculation module 120 of the system 100 determines surrogate ground truth associated with the campaign of interest (step 260). The resulting surrogate ground truth assesses the true effectiveness of the lift models generated from the previous campaign data.

FIG. 4 shows an exemplary process implementing the ground truth generation phase 260 of the process 200 of FIG. 2, according to some embodiments of the present invention. As shown, to calculate the ground truth during the ground truth generation phase 260, the ground truth calculation module 120 is configured to retrieve at step 402 the actual KPI scores (“Scores A1”) for those individuals from the population group who were selected for intervention by the current campaign of interest (from step 306) and were reached by the campaign of interest. These individuals are collectively referred to herein as the “Reached Subgroup.” For example, each of the actual KPI scores (“Scores A1”) for an individual in the Reached Subgroup can represent the net monetary flow generated from that individual actually purchasing the marketed products during a post-campaign time period after being reached during the campaign of interest. Thus, these actual KPI scores (“Scores A1”) represent the true return of targeting by the campaign of interest. In addition, at step 404, the ground truth calculation module 120 is configured to calculate estimated KPI scores (“Scores A2”) for the individual in the Reached Subgroup by applying the trained control C model (from the training phase at step 240) to the data collected on the Reached Subgroup. Each of the estimated KPI scores (“Score A2”) represents a predicted KPI that the corresponding individual would generate had the individual not been reached by the campaign of interest. Further, a lift score for each of the individuals in the Reached Subgroup is generated (step 406) by subtracting the corresponding estimated KPI score determined at step 404 from the actual KPI score determined at step 402 (i.e., Scores A1-Scores A2). Therefore, for those individual in the Reached Subgroup (i.e., those who received a called during the campaign of interest), the higher the lift scores, the better the campaign's initial decision about contacting them.

The remaining individuals in the population group of the previous campaign that were not contacted or reached by the current campaign of interest are collectively referred to hereinafter as the “Unreached Subgroup.” For the Unreached Subgroup of individuals who were not contacted or contacted without being reached by the campaign of interest, the ground truth calculation module 120 is configured to determine the actual KPI scores (Scores B1) for this group as well (step 408). For example, each of the actual KPI scores (Score B1) for an individual in the Unreached Subgroup can represent the net monetary flow generated from that individual actually purchasing the marketed products within a post-campaign time period despite not being reached by the campaign of interest. In addition, at step 410, the ground truth calculation module 120 is configured to calculate estimated KPI scores (Score B2) for the individual in the Unreached Subgroup by applying the trained treatment T model (from the training phase at step 240) to the data collected on the Unreached Subgroup. Each of the estimated KPI scores (Score B2) represents an estimated KPI that the corresponding individual would generate had the individual been reached by the campaign of interest. Thus each of the estimated KPI scores (Score B2) predicts an expected return were the individual in the Unreached Subgroup targeted instead. Further, a lift score for each of the individuals in the Unreached Subgroup is generated (step 412) by subtracting the actual KPI score determined at step 408 from the corresponding estimated KPI score determined at step 410 (i.e., Score B2-Score B1). Therefore, for those individual in the Unreached Subgroup (i.e., those who were not contacted during the campaign of interest), the lower the lift scores, the better the campaign's decision about not contacting them.

In some embodiments, the ground truth calculation module 120 is configured to store the actual KPI scores and estimated KPI scores for both the Reached Subgroup and the Unreached Subgroup in the campaign database 116 of the data store 108 of FIG. 1. In some embodiment, the trained C model for generating the estimated KPI scores for the Reach Subgroup and the trained T model for generating the estimated KPI scores for the Unreached Subgroup are stored in the model repository 118 and retrieved by the ground truth calculation module 120 to perform the pertinent calculations. In some embodiments, the information related to the Reached Subgroup and the Unreached Subgroup is retrieved from the customer database 114 of the data store 108 of FIG. 1.

At step 414, the surrogate ground truth for the campaign of interest is calculated by the ground truth calculation module 120 based on the lift scores generated for the Reached Subgroup (from step 406) and the Unreached Subgroup (from step 412) at the conclusion of the campaign of interest. For example, the ground truth calculation module 120 first combines the lift scores for the Reached Subgroup with the lift scores from the Unreached Subgroup to assemble a combined set of lift scores for the population group. These scores represent an approximation to an unknown ground truth. The ground truth calculation module 120 then ranks the individuals in the population group based on their corresponding lift scores. In the best case scenario, if this ranked list of lift scores calculated after the campaign of interest is the same as the initial ranked list of lifted scores calculated before the campaign of interest based on the previous campaign data (at step 304 of the scoring phase 250), this indicates that the selection of who to call for the campaign of interest (at step 306 of the scoring phase) was the best decision given the T and C models. Alternatively, in the worst case scenario, if this ranked list of lift scores calculated after the campaign of interest is the reverse of the initial ranked list of lifted scores calculated before the campaign of interest, this indicates that the selection of who to call for the campaign of interest was completely wrong and instead the group who were not selected should have been called. In general, the degree of similarity between the two ranked lists of lift scores is an indication of how well the campaign of interest was at selecting individuals to target/call based on AI models, thereby serving as the ground truth for evaluating marketing effectiveness and fairness.

In some embodiments, the ground truth calculation module 120 can selected from the ranked list of individuals those whose scores exceed a predefine threshold (e.g., the top 10%), where the selected individuals represent the surrogate ground truth, i.e., the individuals who should have been contacted by the campaign of interest. In some embodiments, the ground truth calculation module 120 is configured to store the surrogate ground truth information in the campaign database 116 for future analysis and other downstream tasks.

Referring back to the process 200 of FIG. 2, after the surrogate ground truth is determined (at step 260), the fairness determination module 124 of the system 100 of FIG. 1 is configured to evaluate one or more machine-learning fairness metrics based on the data generated from the campaign of interest to uncover unintended bias with respect to one or more protected attributes. The data used by the fairness determination module 124 to calculate the fairness metrics can include (i) the list of individuals selected for targeting at the beginning of the campaign of interest (from step 306), (ii) the list of individuals that represents the surrogate ground truth, i.e., should have been contacted determined at the end of the campaign of interest (from step 414), and (iii) the protected attributes of interest, such as gender, age and/or race. In some embodiment, the list of individuals selected for targeting at the beginning of the campaign of interest and the list of individual representing ground truth can be retrieved from the campaign data repository 116 and/or the customer database 114 of the data store 108 of FIG. 1. In some embodiments, the protected attributes are stored in the fairness evaluation library 122 of the data store 108 of FIG. 1.

The fairness metrics evaluated by the fairness determination module 124 can include one or more of statistical parity, which is the difference of predicted positive comes between unprotected and protected group, disparate impact, which is the ratio of predicted positive outcomes in unprotect and protected groups, predicative equality, which is the change in false positive rates, equal opportunity, which is the change in true positive rates, false negative rate (FNR) difference, which is the change in false negative rates, average odds, which of the average of predictive equality and equal opportunity, and generalized entropy index and Thiel index, which represent entropy-like measures of individual fairness. In some embodiments, statistical parity is calculated using the equation:

Prob[d(X)=1|g(X)]=Prob[d(X)=1].

In some embodiments, disparate impact is calculated using the following equation:

$$\frac{P r o b ( \hat{Y} = 1 \vert D = unprivileged ]}{P r o b ( \hat{Y} = 1 \vert D = privileged ]}$$

In some embodiments, equal opportunity is calculate using the following equation:

TPR_{unprivileged}−TPR_{privileged}

The “privileged” and “unprvileged” designations in the above equation mean groups of individuals who have historically received favorable and unfavorable decisions in a certain situation of interest, respectively. Examples of such a situations can involve predictive algorithm estimating the likelihood of an inmate to re-offend, where the “privileged” group includes white defendants and “unprivileged” group includes black defendants.
In some embodiments, the fairness determination module 124 can cause to display the calculated fairness metrics in the browser of the client computing device 124, such as in a tabular format. These fairness Metrics are consumed by an end-user, e.g., a business stakeholder, to evaluate AI bias in developed AI models (i.e., the T and C models) and to select individuals to contact in a marketing campaign.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®, Google® Cloud).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

1. A computer-implemented method for determining surrogate ground truth to enable fairness evaluation after completion of a campaign of interest, the surrogate ground truth indicating individuals who should have been contacted by the campaign of interest, the computer-implemented method comprising:
receiving, by a computing device, data for the campaign of interest and data for a previous campaign in relation to a population group selected for the previous campaign;
performing, by the computing device before commencement of the campaign of interest, steps including:
generating a trained lift model to predict one or more effects of the previous campaign with respect to at least one key performance indicator (KPI) among the population group, generating the trained lift model comprising:
collecting attribute data of a first group of individuals who were reached by the previous campaign and a second group of individuals who were not reached by the previous campaign;
creating (i) a first training set comprising the collected attribute data of the first group and (ii) a second training set comprising the collected attribute data of the second group:
training a treatment model by applying a first artificial intelligence (AI) algorithm on the first training set to generate a trained treatment model that predicts the at least one KPI for the first group:
training a control model by applying a second AI algorithm on the second training set to generated a trained control model that predicts the at least one KPI for the second group; and
combining the trained treatment model and the trained control model to generate the trained lift model;
ranking the population group based on the trained lift model to generate an initial ranking; and
selecting, from the population group, individuals to contact by the campaign of interest based on the initial ranking; and
calculating, by the computing device, the surrogate ground truth after completion of the campaign of interest that targets the individuals selected from the population group based on the initial ranking, calculating the surrogate truth comprising:
determining actual KPI scores for individuals in a first subgroup that were reached by the campaign of interest, wherein the individuals in the first subgroup are from the individuals selected based on the initial ranking;
scoring the first subgroup with the trained control model of the lift model to generate estimated KPI scores for the individuals in the first subgroup, each estimated KPI score representing an estimated KPI that the corresponding individual would generate had the individual not been reached by the campaign of interest; determining lift scores for the individuals in the first subgroup by subtracting the estimated KPI scores from the actual KPI scores of the first subgroup;
determining actual KPI scores for individuals in a second subgroup that were not reached by the campaign of interest, wherein the individuals in the second group are from the individuals selected based on the initial ranking;
scoring the second subgroup with the trained treatment model of the lift model to generate estimated KPI scores for the individuals in the second subgroup, each score representing an estimated KPI that the corresponding individual would generate had the individual been reached by the campaign of interest;
determining lift scores for the individuals in the second subgroup by subtracting the actual KPI scores from the estimated KPI scores of the second subgroup; and
calculating the surrogate ground truth for the campaign of interest based on the lift scores for the first and second subgroups.

2. The computer-implemented method of claim 1, wherein the KPI represents an amount of net monetary flow in purchase in a given time duration.

3. (canceled)

4. The computer-implemented method of claim 1, further comprising, prior to the commencement of the campaign of interest:
scoring the population group with the trained treatment model to generate a first set of KPI scores that predict the KPI for the individual the population group who were reached by the previous campaign;
scoring the population group using the trained control model to generate a second set of KPI scores that predict the KPI for the individuals in the population group who were not reached by the previous campaign, and
combining the first and second sets of KPI scores to generate a set of initial lift scores for the population group.

5. The computer-implemented method of claim 4, further comprising generating the initial ranking by ranking individuals in the population group based on their respective initial lift scores.

6. The computer-implemented method of claim 5, wherein selecting the individuals to contact by the campaign of interest comprises selecting individuals from the initial ranking of the population group who have initial lift scores higher than a predefined threshold score.

7. The computer-implemented method of claim 1, wherein calculating the surrogate ground truth for the campaign of interest based on the lift scores for the first and second subgroups comprises:
combining the lift scores for the first and second subgroups to form a combined set of lift scores;
ranking individuals in the population group based on their corresponding lift scores in the combined set of lift scores; and
selecting individuals from the population group based on the ranking, wherein the selected individuals represent the surrogate ground truth of those who should have been contacted by the campaign of interest.

8. The computer-implemented method of claim 7, wherein selecting individuals from the population group to represent the surrogate ground truth comprises selecting individuals from the ranking of the population group after the completion of the campaign of interest who have lift scores higher than a predefined threshold score.

9. The computer-implemented method of claim 7, further comprising determining similarity between the ranking of the population group after the completion of the campaign of interest and the initial ranking of the population group to determine effectiveness of the campaign of interest.

10. The computer-implemented method of claim 7, further comprising computing one or more binary fairness metrics based on the initial ranking and the surrogate ground truth to uncover unintended bias with respect to one or more protected attributes.

11. The computer-implemented method of claim 10, wherein the one or more binary fairness metrics include at least one of statistical parity, disparate impact, predictive equality, equal opportunity, false negative rate (FNR) difference, average odds, and generalized entropy index and Theil index.

12. The computer-implemented method of claim 1, wherein a higher value in the lift score for an individual in the first subgroup corresponds to a better decision of the campaign of interest to contact the individual.

13. The computer-implemented method of claim 1, wherein a lower value in the lift score for an individual in the second subgroup corresponds to a better decision of the campaign of interest to not contact the individual.

14. The computer-implemented method of claim 1, wherein scoring the first subgroup with the control model comprises using attributes of the individuals in the first subgroup at the end of the campaign of interest in the control model.

15. The computer-implemented method of claim 1, wherein scoring the second subgroup with the treatment model comprises using attributes of the individuals in the second subgroup at the end of the campaign of interest in the treatment model.

16. The computer-implemented method of claim 1, wherein at least one of the control model or the treatment model comprises a regression model.

17. (canceled)

18. A computer-implemented system for determining surrogate ground truth to enable fairness evaluation after completion of a campaign of interest, the surrogate ground truth revealing individuals who should have been contacted by the campaign of interest, the computer-implemented system comprising:
a server computing device; and
a memory storing instructions executable by the service computing device, wherein the instructions, when executed, configure the computer-implemented system to provide:
an input module for receiving data for the campaign of interest and data for a previous campaign in relation to a population group selected for the previous campaign;
a lift model generator configured to generate, before commencement of the campaign of interest, a trained lift model by:
collecting attribute data of a first group of individuals who were reached by the previous campaign and a second group of individuals who were not reached by the previous campaign;
creating (i) a first training set comprising the collected attribute data of the first group and (ii) a second training set comprising the collected attribute data of the second group;
training a treatment model by applying a first artificial intelligence (AI) algorithm on the first training set to generate a trained treatment model that predicts the at least one KPI for the first group;
training a control model by applying a second AI algorithm on the second training set to generated a trained control model that predicts the at least one KPI for the second group; and
combining the trained treatment model and the trained control model to generate the trained lift model;
the lift model generator further configured to generate an initial ranking of the population group based on the trained lift model, and select individuals from the population group to contact by the campaign of interest based on the initial ranking;
a scoring engine configured to generate, after completion of the campaign of interest, (i) lift scores for individuals in a first subgroup that were reached by the campaign of interest based on the trained control model, wherein individuals in the first subgroup are from the individuals selected based on the initial ranking and (ii) lift scores for individuals in a second subgroup that were not reached by the campaign of interest based on the trained treatment model, wherein the individuals in the second group are from the individuals selected based on the initial ranking;
a ground truth calculation module configured to calculate the surrogate ground truth for the campaign of interest based on the lift scores for the first and second subgroups; and
a fairness evaluation library for storing one or more binary fairness metrics applicable to the surrogate ground truth to uncover unintended bias.

19. The computer-implemented system of claim 18, wherein the scoring engine is executed by the server computing device to generate the lift scores for the individuals in the first subgroup of the current population group by:
determining actual KPI scores for the individuals in the first subgroup;
scoring the first subgroup with the trained control model to generate estimated KPI scores for the individuals in the first subgroup, each estimated KPI score representing an estimated KPI that the corresponding individual would generate had the individual not been reached by the campaign;
determining the lift scores for the individuals in the first subgroup by subtracting the estimated KPI scores from the actual KPI scores of the first subgroup.

20. The computer-implemented system of claim 18, wherein the scoring engine is executed by the server computing device to generate the lift scores for the individuals in the second subgroup of the current population group by:
determining actual KPI scores for individuals in the second subgroup;
scoring the second subgroup with the trained treatment model to generate estimated KPI scores for the individuals in the second subgroup, each estimated KPI score representing an estimated KPI that the corresponding individual would generate had the individual been reached by the campaign; and
determining the lift scores for the second subgroup by subtracting the actual KPI scores from the estimated KPI scores of the second subgroup.
